(19) United States
(12) Patent Application Publication
(10) Pub. No.: US 2013/0048466 A1
(43) Pub. Date: Feb. 28, 2013

(54) CONVEYOR APPARATUS, PROCESSING APPARATUS, CONVEYANCE METHOD, AND PROCESSING METHOD

(71) Applicant: Ken Tsunoi, Saitama (JP)

(72) Inventor: Ken Tsunoi, Saitama (JP)

(73) Assignee: SONY CORPORATION, Tokyo (JP)

(21) Appl. No.: 13/591,468

(22) Filed: Aug. 22, 2012

(30) Foreign Application Priority Data
Aug. 31, 2011 (JP) 2011-189141

(51) Int. Cl. B65G 37/00

(52) U.S. Cl. 198/346.2; 198/602

(57) ABSTRACT

A conveyor apparatus includes a driving source, a plurality of conveyors, a moving mechanism, and a transmission mechanism. The plurality of conveyors are driven by the driving source to each convey a processing object along a first direction. The moving mechanism is capable of moving at least one conveyor of the plurality of conveyors along a second direction different from the first direction. The transmission mechanism includes a clutch configured to perform power transmission from the driving source to the at least one conveyor and to cut off the power transmission and is capable of transmitting a power from the driving source to the plurality of conveyors.

### BACKGROUND

The present disclosure relates to a conveyor apparatus that conveys a processing object being a substrate, a processing apparatus including such a conveyor apparatus, a conveyance method therefor, and a processing method therefor.

Japanese Patent Application Laid-open No. HEI 11-160044 (hereinafter, referred to as Patent Document 1) discloses a technique relating to an appearance inspection apparatus for an mounted substrate. In this apparatus, a substrate carried by a substrate carrying portion is imaged by a camera provided thereabove and the image is analyzed by a computer, to thereby inspect an appearance of the substrate. Conveyor units are provided on both sides of the substrate carrying portion. The substrate is loaded from the conveyor unit on one side to the substrate carrying portion and the substrate after inspection is unloaded to the conveyor unit on the other side (e.g., see paragraph [0010] of specification and FIG. 1 of Patent Document 1).

Japanese Patent Application Laid-open No. 2009-253070 (hereinafter, referred to as Patent Document 2) discloses a technique relating to a component mounting apparatus. In this apparatus, a plurality of conveyors are divided. A conveyance direction of a substrate of each conveyor is a direction of from a load side (right-hand side in FIG. 4) to an unload side (left-hand side in FIG. 4) with respect to this apparatus. A conveyor drive unit allows each conveyor to move in a direction orthogonal to the conveyance direction. With this, high-efficient conveyance of the substrate is realized (e.g., see of paragraph [0042] of specification and FIG. 4 of Patent Document 2).

### SUMMARY

In the conveyor apparatus described in Patent Document 2, the conveyor drive unit allows each conveyor to move in the direction orthogonal to the conveyance direction of each conveyor, and hence driving for conveyance by each conveyor is inevitably independent of each other. As a result, the number of components and mechanisms increase, which makes the configuration complex.

In view of the above-mentioned circumstances, there is a need for providing a conveyor apparatus capable of realizing a conveyance mechanism including a plurality of conveyors with a simple configuration, a processing apparatus including such a conveyor apparatus, a conveyance method therefor, and a processing method therefor.

According to an embodiment of the present disclosure, there is provided a conveyor apparatus including a driving source, a plurality of conveyors, a moving mechanism, and a transmission mechanism.

The plurality of conveyors are driven by the driving source to each convey a processing object along a first direction.

The moving mechanism is capable of moving at least one conveyor of the plurality of conveyors along a second direction different from the first direction.

The transmission mechanism includes a clutch configured to perform power transmission from the driving source to the at least one conveyor and to cut off the power transmission and is capable of transmitting a power from the driving source to the plurality of conveyors.

In the embodiment of the present disclosure, due to the provision of the clutch to the transmission mechanism, when the moving mechanism moves the at least one conveyor, the power transmission from the driving source to this conveyor is cut off. With this, also in the conveyor apparatus having a function of moving the conveyor along the second direction, it is possible to realize driving of the plurality of conveyors with few driving sources. Thus, it is possible to realize a conveyance mechanism including a plurality of conveyors with a simple configuration.

The driving source may include an output member connected to the transmission mechanism, and the clutch may be provided to rotate coaxially with the output member. Due to the provision of the clutch that rotates coaxially with the output member of the driving source, it is possible to suppress mechanical loss upon the power transmission from a motor to the clutch.

The plurality of conveyors may include a work conveyor that is capable of clamping the processing object and to which the power is inputted via the clutch, and a conveyor configured to one of load the processing object to the work conveyor and unload the processing object from the work conveyor.

With this, the conveyor apparatus can load the object to the work conveyor using the load conveyor or unload the object from the work conveyor using the unload conveyor. Further, the moving mechanism can move, upon conveyance of the processing object, the work conveyor so that the power of the power source is transmitted to the work conveyor and can move, upon predetermined processing on the object, the work conveyor so that the transmission is cut off.

The clutch may include an input-side member that includes a first material and is connected to a side of the driving source, and an output-side member that includes a second material having a different hardness from the first material and is connected to the at least one conveyor.

By appropriately selecting hardnesses of the first material and the second material, it is possible to provide the input-side member and the output-side member with different wear resistances. For example, it is possible to provide one of the input-side member and the output-side member, which is easy to maintain or can be maintained at low cost, with a softer material.

The clutch may include an input-side member including an engagement member, and an output-side member including an engagement member engageable to the engagement member. In this case, at least one of the engagement member of the input-side member and the engagement member of the output-side member may have a pin shape. With this, mutual engagement of the engagement members becomes easy.

According to an embodiment of the present disclosure, there is provided a processing apparatus including a driving source, a plurality of conveyors, a transmission mechanism, a processor, and a moving mechanism.

The plurality of conveyors are driven by the driving source to each convey a processing object along a first direction.

The transmission mechanism includes a clutch configured to perform power transmission from the driving source to the at least one conveyor of the plurality of conveyors and to cut off the power transmission and is capable of transmitting a power from the driving source to the plurality of conveyors.

The processor is configured to subject the processing object to predetermined processing.

The moving mechanism is configured to move, upon cut-off of the power transmission by the clutch, the at least one conveyor along a second direction different from the first direction so that the at least one conveyor is located in the processor.

In the embodiment of the present disclosure, when the moving mechanism moves the at least one conveyor, the transmission mechanism uses the clutch to cut off power transmission from the driving source to the conveyor. With this, also in the processing apparatus including the moving mechanism capable of moving the conveyor along the second direction, it is possible to realize driving of the plurality of conveyors with few driving sources.

According to an embodiment of the present disclosure, there is provided a conveyance method including supplying a power from a driving source to a plurality of conveyors via a transmission mechanism, to thereby cause the plurality of conveyors to convey a processing object along a first direction.

A clutch provided to the transmission mechanism is used to cut off power transmission from the driving source to at least one conveyor of the plurality of conveyors.

The at least one conveyor, to which the power transmission is cut off, moves along a second direction different from the first direction.

According to an embodiment of the present disclosure, there is provided a processing method including supplying a power from a driving source to a plurality of conveyors via a transmission mechanism, to thereby cause the plurality of conveyors to convey a processing object along a first direction.

A clutch provided to the transmission mechanism is used to cut off power transmission from the driving source to at least one conveyor of the plurality of conveyors.

The at least one conveyor, to which the power transmission is cut off, moves along a second direction different from the first direction.

The processing object carried by the at least one conveyor moved is subjected to predetermined processing.

As described above, according to the present disclosure, it is possible to realize a conveyance mechanism including a plurality of conveyors with a simple configuration.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a plan view schematically showing an appearance inspection apparatus as an example of a processing apparatus according to a first embodiment of the present disclosure;

FIG. 2 is a plan view schematically showing a conveyor unit as viewed from above as in FIG. 1;

FIG. 3 is a plan view showing a driving source and a periphery thereof in an enlarged state as viewed from above;

FIG. 4 is a perspective view showing an example of a clutch;

FIG. 5 are views for explaining an engaged state of the clutch;

FIG. 6 are views showing operations of the appearance inspection apparatus in order; and

FIG. 7 is a plan view schematically showing a conveyor unit according to a second embodiment of the present disclosure.

### DETAILED DESCRIPTION OF EMBODIMENTS

Hereinafter, embodiments of the present disclosure will be described with reference to the drawings.

### First Embodiment

(Entire Configuration of Appearance Inspection Apparatus)

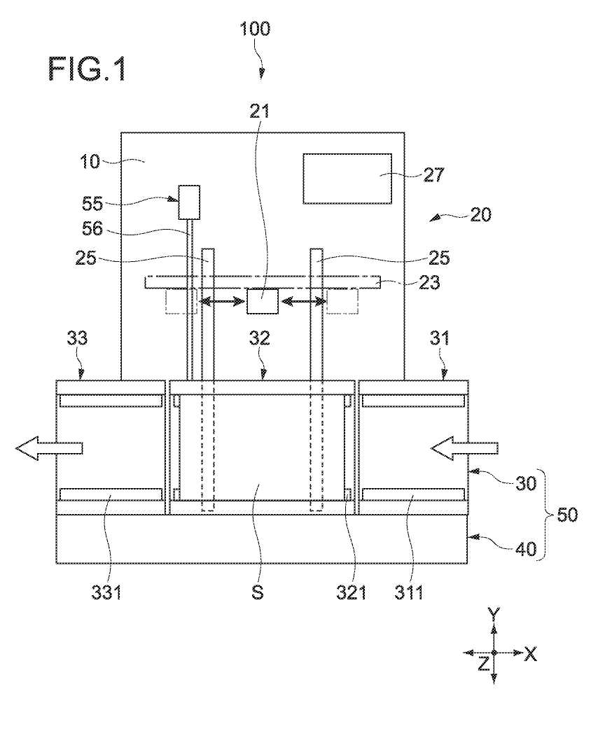

FIG. 1 is a plan view schematically showing an appearance inspection apparatus as an example of a processing apparatus according to a first embodiment of the present disclosure.

The appearance inspection apparatus 100 is an apparatus that inspects, for example, an appearance of a circuit substrate (hereinafter, simply referred to as substrate) as an inspection object (processing object). For example, the appearance inspection apparatus 100 inspects a print state of a circuit wiring, a print state of a solder, damages, and stains or inspects defects of electronic components on the substrate and misalignment of mounting positions of the electronic components.

The appearance inspection apparatus 100 includes an inspection unit 20 serving as a processor, a conveyor unit 50 (conveyor apparatus), a base frame 10 that supports the inspection unit 20 and the conveyor unit 50 from below, and the like. The conveyor unit 50 is located on a front side (lower side in FIG. 1) of the appearance inspection apparatus 100. The inspection unit 20 is located on a rear side (upper side in FIG. 1) with respect to the conveyor unit 50.

The inspection unit 20 inspects an appearance of a substrate S as described above. Typically, the inspection unit 20 includes a camera 21 and a camera moving mechanism 23. The camera moving mechanism 23 moves the camera 21 in a predetermined direction, for example, along an X-axis direction in FIG. 1.

The camera moving mechanism 23 is constituted of, for example, a ball-screw driving mechanism, a belt driving mechanism, or a rack-and-pinion driving mechanism. Further, the inspection unit 20 includes an illumination apparatus (not shown) located around the camera 21. With the illumination apparatus, it is possible to obtain reflected light from the substrate S, which is optimal for imaging by the camera 21. As will be described later, the camera 21 and the camera moving mechanism 23 are located in positions higher than a height position (position in a Z-axis direction) of the substrate S carried by a work conveyor 32 in center.

It should be noted that a computer 27 that generally controls the appearance inspection apparatus 100 is provided behind the inspection unit 20. The position of the computer 27 can be appropriately changed. Further, the inspection unit 20 includes a display and an input operation unit that are located in arbitrary positions. The display and the input operation unit are electrically connected to the computer 27.

(Configuration of Conveyor Unit)

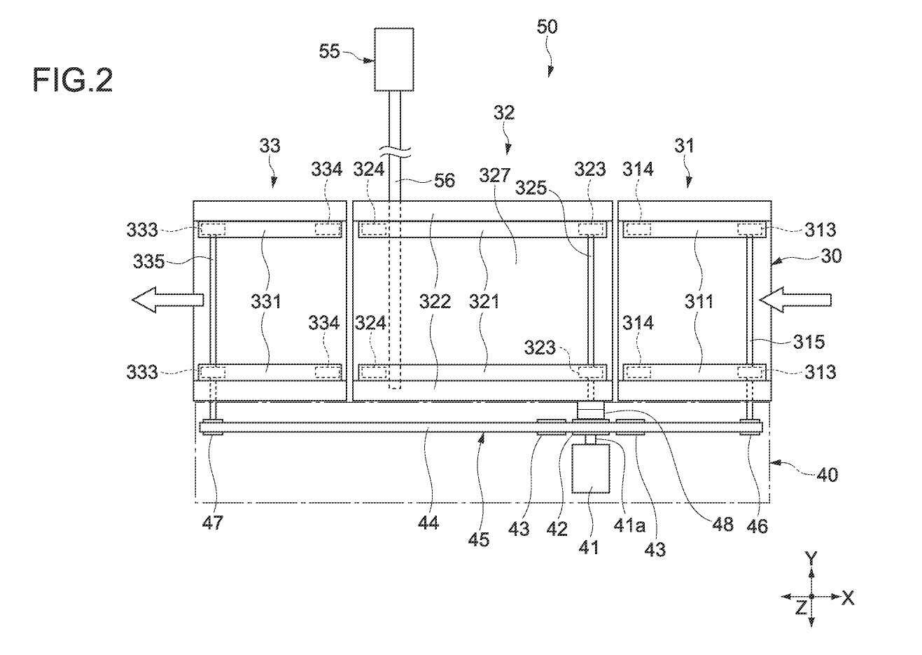

FIG. 2 is a plan view schematically showing the conveyor unit 50 as viewed from above as in FIG. 1.

The conveyor unit 50 includes a load conveyor 31, the work conveyor 32, and an unload conveyor 33, which are arranged in line along the X-axis direction. Further, the conveyor unit 50 includes a drive unit 40 that performs driving for generating a conveyance force by those three conveyors. The drive unit 40 is located on a front side with respect to the positions of the three conveyors 31 to 33 (see also FIG. 1).

Those conveyors 31 to 33 are adapted to convey the substrate S from a right-hand side to a left-hand side in FIG. 2, that is, along the X-axis direction. For example, in the case where the appearance inspection apparatus 100 is used in line together with other apparatuses, the load conveyor 31 receives the substrate S unloaded from one of the other apparatuses, which is adjacent to the appearance inspection apparatus 100 on the right-hand side in FIG. 1, and loads it to the work conveyor 32. The unload conveyor 33 unloads the substrate S after inspection, which is received from the work conveyor 32, to the other of the other apparatuses, which is adjacent to the appearance inspection apparatus 100 on the left-hand side in FIG. 1.

The work conveyor 32 is sandwiched between the load conveyor 31 and the unload conveyor 33. The work conveyor 32 includes a pair of endless belts 321 arranged in a Y-axis direction, drive pulleys 323 and driven pulleys 324 that rotate the endless belts 321, a drive shaft 325 that connects the drive pulleys 323 to each other, and a pair of rotation guides (not shown) that rotatably support the drive pulleys 323 and the driven pulleys 324.

The work conveyor 32 further includes side guides 322 and a base plate 327. The side guides 322 are correspondingly provided outside the pair of rotation guides to cover the pair of rotation guides. The base plate 327 is provided below the pair of side guides 322 to integrally support the pair of side guides 322. The rotation guides, the side guides 322, and the like may adopt well known various structures. For example, the rotation guides may be provided inside the endless belts 321 in the Y-axis direction. In this case, the drive shaft 325 is rotatably supported.

The load conveyor 31 and the unload conveyor 33 have substantially the same configurations and functions as the work conveyor 32 described above. The load conveyor 31 includes pulleys 313 and 314, endless belts 311, and the like. The unload conveyor 33 includes pulleys 333 and 334, endless belts 331, and the like. The configuration of the work conveyor 32 that is different from those of the load conveyor 31 and the unload conveyor 33 will be described below.

Although not shown, the work conveyor 32 includes a mechanism that raises and lowers the pairs of belts and the pairs of rotation guides integrally. The raising and lowering mechanism only needs to adopt a well known structure. For example, the raising and lowering mechanism is installed in the base plate 327 (or frame). By this raising and lowering mechanism raising the pairs of belts and the pairs of rotation guides integrally so that edges of the substrate S are sandwiched between the pair of endless belts 321 and upper portions of the side guides 322, the substrate S is clamped. How to clamp the substrate S is not limited to such means and can be appropriately changed.

As shown in FIG. 1, the conveyor unit 50 includes a moving mechanism 55. The moving mechanism 55 moves the work conveyor 32 in a direction orthogonal to a conveyance direction of the substrate S by the three conveyors 31 to 33, that is, along guide rails 25 and 25 provided along the Y-axis direction. For example, a ball-screw driving mechanism is used as the moving mechanism 55. A ball screw 56 of the ball-screw driving mechanism is rotatably connected to a lower portion of the base plate 327 of the work conveyor 32.

By driving of the moving mechanism 55, upon inspection of the appearance of the substrate S by the inspection unit 20, the work conveyor 32 moves from an initial position shown in FIGS. 1 and 2 to a position on a side of the inspection unit 20 on the rear side and then the inspection of the appearance of the substrate S is started.

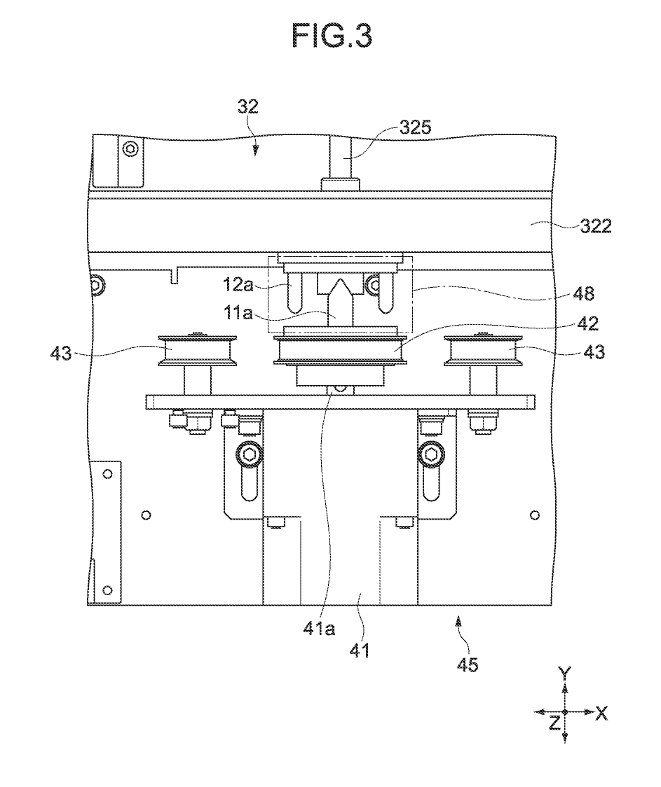

The drive unit 40 includes a motor 41 serving as a driving source and a transmission mechanism 45 capable of transmitting a power from the motor 41 to the three conveyors 31 to 33. FIG. 3 is a plan view showing the motor 41 and a periphery thereof in an enlarged state as viewed from above. As shown in FIGS. 2 and 3, the transmission mechanism 45 includes a drive pulley 42, driven pulleys 46 and 47, and an endless belt 44. The drive pulley 42 is provided to an output shaft 41a of the motor 41. The driven pulleys 46 and 47 are located on a load side and an unload side, respectively. The endless belt 44 is trained over the drive pulley 42 and the driven pulleys 46 and 47. Further, the transmission mechanism 45 includes a clutch 48 provided on an output side of the drive pulley 42.

It should be noted that the endless belts 321 in the work conveyor 32 and the endless belt 44 in the transmission mechanism 45 are not shown in FIG. 3. The output shaft 41a of the motor 41 constitutes an entire output member of the driving source or a part of the output member of the driving source. Tension pulleys 43 and 43 are provided between the drive pulley 42 and each of the driven pulleys 46 and 47.

The motor 41 may be the motor 41 in which a reducer is installed. Alternatively, as a part of the driving source, the reducer may be provided separately from the motor 41.

The output side of the drive pulley 42 is connected to the drive shaft 325 of the work conveyor 32 via the clutch 48. As shown in FIG. 2, an output side of the driven pulley 46 on the load side is connected to a shaft 315 that rotates the pulleys 313 of the load conveyor 31. Further, an output side of the driven pulley 47 on the unload side is connected to a shaft 335 that rotates the pulleys 333 of the unload conveyor 33. With this configuration of the transmission mechanism 45, the single motor 41 can synchronously drive the three conveyors 31 to 33.

The clutch 48 performs power transmission from the motor 41 to the work conveyor 32 and cuts off the power transmission. The clutch 48 is provided on the output side of the drive pulley 42 as described above. Specifically, the clutch 48 is provided to be rotatable coaxially with the output shaft 41a of the motor 41. With this configuration, it is possible to suppress a mechanical loss upon power transmission from the motor 41 to the clutch 48.

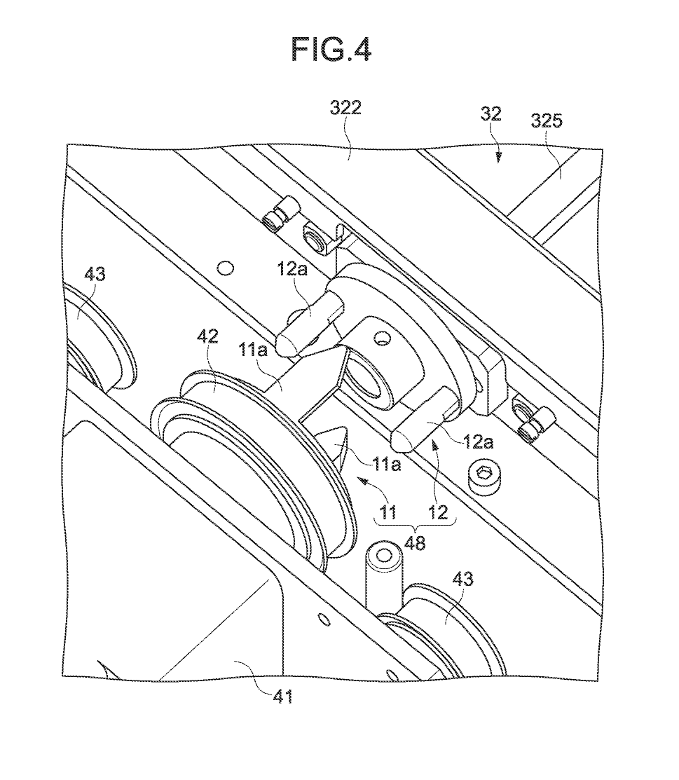

FIG. 4 is a perspective view showing the clutch 48. It should be noted that the endless belt 44 in the transmission mechanism 45 and the endless belts 321 in the work conveyor 32 are not shown also in FIG. 4.

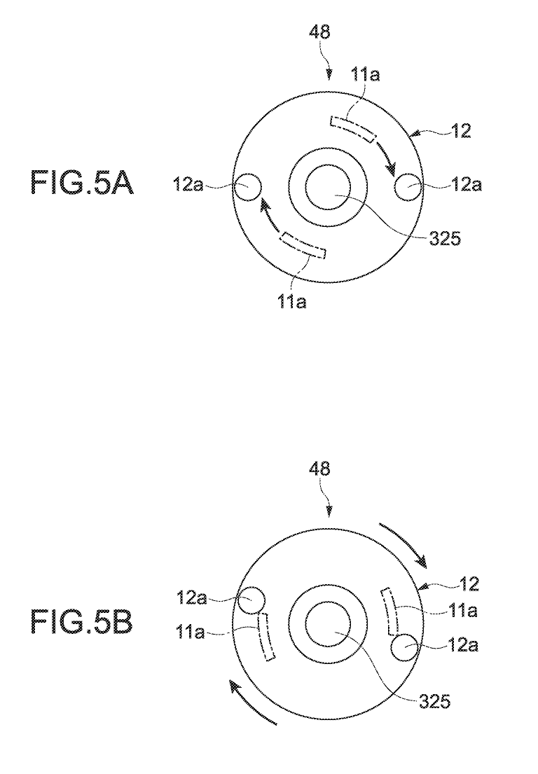

As shown in FIGS. 3 and 4, the clutch 48 includes an input-side member 11 and an output-side member 12. The input-side member 11 includes blade-shaped protrusion members (engagement member) 11a connected to the drive pulley 42. The output-side member 12 includes pin-shaped protrusion members (engagement member) 12a connected to the drive shaft 325 of the work conveyor 32. The pin shape means such a shape that each of the protrusion members 12a is tapered toward its tip end. For example, as shown in FIGS. 5A and 5B, the protrusion members 11a and 12a are engaged by rotation of the motor 41 and integrally rotate while keeping the engaged state. With this, the power of the motor 41 is transmitted to the drive shaft 325 of the work conveyor 32.

The protrusion members 11a and 12a include materials having different hardnesses. With this configuration, it is possible to provide the protrusion members 11a and 121a with different wear resistances. For example, it is possible to provide those of the protrusion members 11a and 12a, which are easy to maintain or can be maintained at low cost, with softer materials.

In this embodiment, the protrusion members 12a on the output side are formed of a softer material than the protrusion members 11a on the input side. Configuring in this manner is because the protrusion members 11a on the input side are not easily exchanged by new protrusion members 11a or the costs of the protrusion members 11a are higher than the protrusion members 12a on the output side due to, for example, direct coupling to the drive pulley 42.

It should be noted that, in this embodiment, the clutch 48 may be located on a side closer to the unload conveyor 33 than the load conveyor 31. In this case, a shaft that connects the pulleys 324, which is close to the clutch 48, to each other is provided and the clutch 48 is connected to this shaft.

(Operations of Appearance Inspection Apparatus)

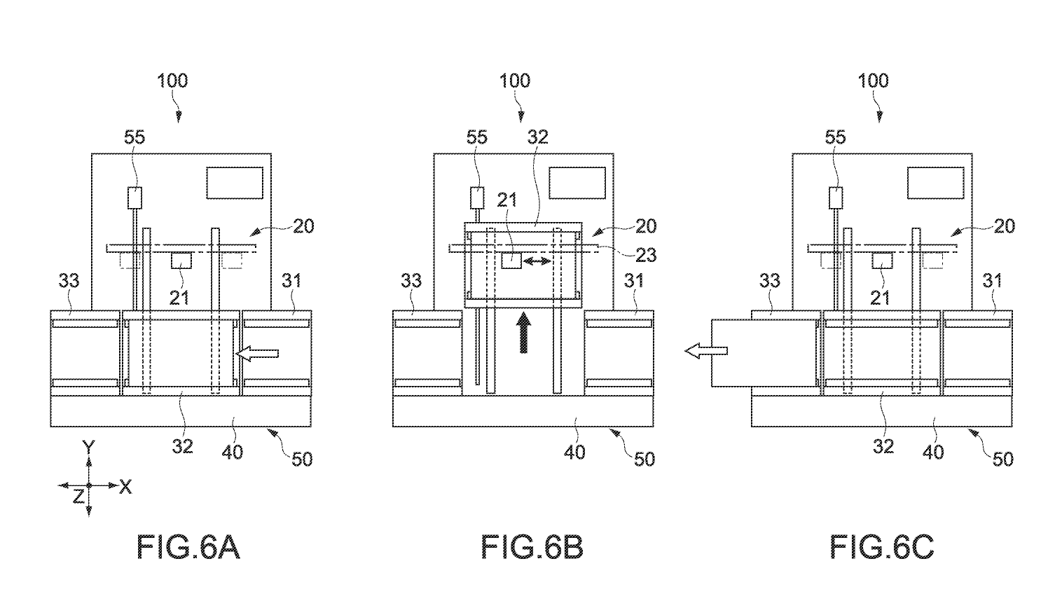

FIG. 6 are views showing operations of the appearance inspection apparatus 100 in order.

As shown in FIG. 6A, driving of the drive unit 40 of the conveyor unit 50 conveys the substrate S from the outside to the position of the work conveyor 32 via the load conveyor 31. Then, the driving of the drive unit 40 is stopped.

Typically, when the substrate S is conveyed to a predetermined position on the endless belt 44 of the work conveyor 32, the substrate S abuts against a mechanical stopper (not shown) and is physically stopped. Then, the substrate S in the stop position is detected by a sensor (not shown) (e.g., optical sensor). By a controller that controls the conveyor unit 50 sending a stop signal to the motor 41 according to this detection signal, the driving of the drive unit 40 is stopped.

When the driving of the drive unit 40 is stopped, the work conveyor 32 clamps the substrate S. Then, as shown in FIG. 6B, driving of the moving mechanism 55 moves the work conveyor 32 rearwards and the work conveyor 32 stops at a predetermined position. The rearward movement of the work conveyor 32 from the initial position cuts off the power of the motor 41 to the work conveyor 32.

For example, the predetermined position only needs to be set by a predetermined amount of movement by the moving mechanism 55. Alternatively, the predetermined position is such a position of the substrate S that an alignment mark (not shown) provided on the substrate S is imaged within an imaging range by the camera 21 in a still state, the camera 21 being provided to the inspection unit 20.

When the work conveyor 32 is stopped in the predetermined position, inspection of the substrate S by the inspection unit 20 is started. While the computer 27 is moving the camera 21 along the X-axis direction using the camera moving mechanism 23 and the substrate S clamped by the work conveyor 32 along the Y-axis direction using the moving mechanism 55, the substrate S is imaged by the camera 21 from above. That is, the camera 21 images the substrate S while moving in a two-dimension of an X-Y plane relative to the substrate S. In this manner, the inspection of the substrate S is performed.

When the inspection of the substrate S is terminated, the moving mechanism 55 moves the work conveyor 32 to the initial position (position shown in FIG. 6A). When the work conveyor 32 moves to the initial position, the input-side member 11 and the output-side member 12 of the clutch 48 are made engageable to each other (see FIG. 3). That is, the power of the motor 41 is made to be transmittable to the work conveyor 32.

Here, in this embodiment, those of the protrusion members 11a and 12a of the clutch 48 (e.g., the protrusion members 12a on the output side) are formed in a pin shape. Thus, in the middle of the work conveyor 32 returning to the initial position, even when the pin-shaped protrusion members 12a and the blade-shaped protrusion members 11a are located in the same rotation angle position, the pin-shaped protrusion members 12a are allowed to easily push away the blade-shaped protrusion members 11a (mainly against cogging torque of the motor 41).

As shown in FIG. 6C, after the work conveyor 32 is returned to the initial position, re-driving of the drive unit 40 actuates each of the conveyors 31 to 33. With this, the substrate S is unloaded outside via the unload conveyor 33.

As described above, in this embodiment, due to the provision of the clutch 48 to the transmission mechanism 45, when the moving mechanism 55 moves the work conveyor 32, the power transmission from the motor 41 to the work conveyor 32 is cut off. With this, also in the apparatus having a function of moving the conveyor in the Y-axis direction, the driving of the conveyors 31 to 33 can be realized with few driving sources. Thus, it is possible to realize a conveyance mechanism including a plurality of conveyors with a simple configuration.

### Second Embodiment

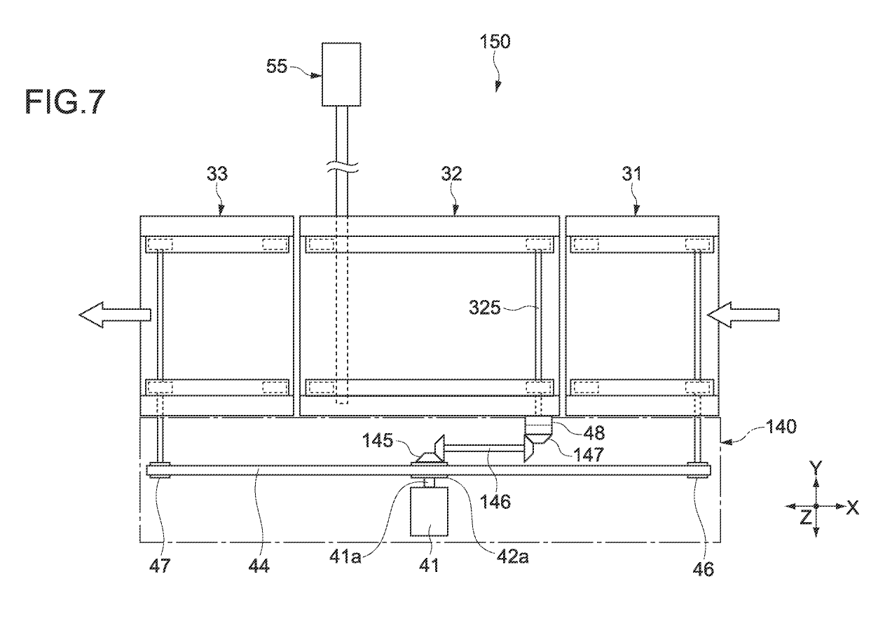

FIG. 7 is a plan view schematically showing a conveyor unit according to a second embodiment of the present disclosure. In the following, descriptions of those the same as the members, the functions, and the like of the conveyor unit 50 according to the embodiment shown in FIGS. 1 and 2 and the like will be simplified or omitted and different points will be mainly described.

In this conveyor unit 150, a motor 41 is located in a substantially center position in an X-axis direction. A drive pulley 42a is connected to an output shaft 41a of the motor 41. A clutch 48 is connected to an output side of a drive pulley 42 via a bevel gear 145, a bevel geared shaft 146 provided along the X-axis direction, and a bevel gear 147. The clutch 48 is connected to a drive shaft 325 of a work conveyor 32 in a position closer to a load conveyor 31 than an unload conveyor 33.

As described above, by the use of the bevel gears 145 and 147 and the bevel geared shaft 146, the position of the motor 41 can be set in the center.

Alternatively, the position of the motor 41 may be an arbitrary position other than the center in the X-axis direction. Alternatively, as shown in FIG. 7, the motor 41 may be provided in substantially the center in the X-axis direction, two bevel geared shafts 146 may be provided in both of left- and right-hand directions in FIG. 7, and two clutches 48 may be correspondingly provided on a side closer to the load conveyor 31 and on a side closer to the unload conveyor 33.

### Other Embodiment

The present disclosure is not limited to the above-mentioned embodiments described above and other various embodiments can be made.

In the clutch 48 according to each of the above-mentioned embodiments, the protrusion members 11a of the input-side member 11 are formed in a blade shape and the protrusion members 12a of the output-side member 12 are formed in a pin shape. However, those protrusion members may be formed in any shape as long as they can rotate integrally in a mutually engaged state. For example, both of those protrusion members may be formed in a blade shape (plate shape) or a pin shape. Further, in each of the above-mentioned embodiments, the two protrusion members 11a and the two protrusion members 12a are provided. However, one protrusion member 11a and one protrusion member 12a may be provided or three or more protrusion members 11a and three or more protrusion members 12a may be provided.

For the clutch, other than the above-mentioned engagement method, any methods may be adopted, for example, a friction method (that is equivalent to the engagement method in a micro view), a magnet method, an electromagnetic method, or a combination method of at least two methods of them.

Although the endless belt 44 is provided as a part of the transmission mechanism 45 in each of the above-mentioned embodiments, the endless belt 44 may be replaced by a chain. Further, in the transmission mechanism 45, the positions of the drive pulley 42, the driven pulleys 46 and 47, and tension pulleys are not limited to those as in the above-mentioned embodiments and can be appropriately changed.

Although the moving direction of the camera 21 by the camera moving mechanism 23 in the inspection unit 20 is only the X-axis direction in each of the above-mentioned embodiments, movement in both of the X-axis direction and Y-axis direction may be adopted. In this case, upon the inspection of the substrate S by the inspection unit 20, the movement of the work conveyor 32 by the moving mechanism 55 along the Y-axis direction is unnecessary.

In each of the above-mentioned embodiments, the moving mechanism 55 moves the work conveyor 32 being one conveyor of the three conveyors 31 to 33 and the work conveyor 32 is provided with the clutch 48. However, for example, two or more conveyors may be provided to be movable in such an appearance inspection apparatus 100 or other apparatuses and the two or more movable conveyors may be each provided with a clutch.

Although the three conveyors 31 to 33 are exemplified in each of the above-mentioned embodiments, for example, the conveyor unit 50 may employ such a form that either one of the load conveyor 31 and the unload conveyor 33 is omitted, that is, two conveyors are provided. Alternatively, the present disclosure is also applicable to a conveyor apparatus including four or more conveyors.

Although the conveyance direction (X-axis direction) of the substrate S by each of the conveyors 31 to 33 is orthogonal to the moving direction of the work conveyor 32 by the moving mechanism 55, those directions do not need to be orthogonal to each other and may obliquely intersect each other. In this case, by setting the outer shape of each conveyor not to be an almost rectangular shape in a plan view as shown in FIG. 2 and the like, but to be an almost parallelogram shape in a plan view, oblique movement of the conveyor is realized.

In the above description, the appearance inspection apparatus is exemplified as the processing apparatus. However, a component mounting apparatus that mounts electronic components on the circuit substrate S or a printing apparatus that prints a wiring on the circuit substrate S may be used as the processing apparatus. Alternatively, the processing apparatus may be any apparatus, for example, a processing machine, a vacuum processing apparatus, or an exposure apparatus.

The processing object is not limited to the circuit substrate S and may be a glass substrate S, a semiconductor substrate S, or a metal substrate S. The processing object is not limited to those plate-shaped products and may be a three-dimensional product having a large thickness.

At least two of the features in each of the above-mentioned embodiments may be combined together.

The present disclosure may also take the following configurations.
(1) A conveyor apparatus, including:

a driving source;

a plurality of conveyors that are driven by the driving source to each convey a processing object along a first direction;

a moving mechanism that is capable of moving at least one conveyor of the plurality of conveyors along a second direction different from the first direction; and

a transmission mechanism that includes a clutch configured to perform power transmission from the driving source to the at least one conveyor and to cut off the power transmission and that is capable of transmitting a power from the driving source to the plurality of conveyors.
(2) The conveyor apparatus according to (1), in which

the driving source includes an output member connected to the transmission mechanism, and

the clutch is provided to rotate coaxially with the output member.
(3) The conveyor apparatus according to (1) or (2), in which

the plurality of conveyors include
a work conveyor that is capable of clamping the processing object and to which the power is inputted via the clutch, and
a conveyor configured to one of load the processing object to the work conveyor and unload the processing object from the work conveyor.
(4) The conveyor apparatus according to any one of (1) to (3), in which

the clutch includes
an input-side member that includes a first material and is connected to a side of the driving source, and
an output-side member that includes a second material having a different hardness from the first material and is connected to the at least one conveyor.
(5) The conveyor apparatus according to any one of (1) to (4), in which

the clutch includes
an input-side member including an engagement member, and
an output-side member including an engagement member engageable to the engagement member, and

at least one of the engagement member of the input-side member and the engagement member of the output-side member has a pin shape.
(6) A processing apparatus, including:

a driving source;

a plurality of conveyors that are driven by the driving source to each convey a processing object along a first direction;

a transmission mechanism that includes a clutch configured to perform power transmission from the driving source to the at least one conveyor of the plurality of conveyors and to cut off the power transmission and that is capable of transmitting a power from the driving source to the plurality of conveyors;

a processor configured to subject the processing object to predetermined processing; and

a moving mechanism configured to move, upon cut-off of the power transmission by the clutch, the at least one conveyor along a second direction different from the first direction so that the at least one conveyor is located in the processor.
(7) A conveyance method, including:

supplying a power from a driving source to a plurality of conveyors via a transmission mechanism, to thereby cause the plurality of conveyors to convey a processing object along a first direction;

using a clutch provided to the transmission mechanism to cut off power transmission from the driving source to at least one conveyor of the plurality of conveyors; and

moving the at least one conveyor, to which the power transmission is cut off, along a second direction different from the first direction.
(8) A processing method, including:

supplying a power from a driving source to a plurality of conveyors via a transmission mechanism, to thereby cause the plurality of conveyors to convey a processing object along a first direction;

using a clutch provided to the transmission mechanism to cut off power transmission from the driving source to at least one conveyor of the plurality of conveyors;

moving the at least one conveyor, to which the power transmission is cut off, along a second direction different from the first direction; and

subjecting the processing object carried by the at least one conveyor moved, to predetermined processing.

The present disclosure contains subject matter related to that disclosed in Japanese Priority Patent Application JP 2011-189141 filed in the Japan Patent Office on Aug. 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A conveyor apparatus, comprising:
a driving source;
a plurality of conveyors that are driven by the driving source to each convey a processing object along a first direction;
a moving mechanism that is capable of moving at least one conveyor of the plurality of conveyors along a second direction different from the first direction; and
a transmission mechanism that includes a clutch configured to perform power transmission from the driving source to the at least one conveyor and to cut off the power transmission and that is capable of transmitting a power from the driving source to the plurality of conveyors.

2. The conveyor apparatus according to claim 1, wherein
the driving source includes an output member connected to the transmission mechanism, and
the clutch is provided to rotate coaxially with the output member.

3. The conveyor apparatus according to claim 1, wherein
the plurality of conveyors include
a work conveyor that is capable of clamping the processing object and to which the power is inputted via the clutch, and
a conveyor configured to one of load the processing object to the work conveyor and unload the processing object from the work conveyor.

4. The conveyor apparatus according to claim 1, wherein
the clutch includes
an input-side member that includes a first material and is connected to a side of the driving source, and
an output-side member that includes a second material having a different hardness from the first material and is connected to the at least one conveyor.

5. The conveyor apparatus according to claim 1, wherein
the clutch includes
an input-side member including an engagement member, and
an output-side member including an engagement member engageable to the engagement member, and
at least one of the engagement member of the input-side member and the engagement member of the output-side member has a pin shape.

6. A processing apparatus, comprising:
a driving source;
a plurality of conveyors that are driven by the driving source to each convey a processing object along a first direction;
a transmission mechanism that includes a clutch configured to perform power transmission from the driving source to the at least one conveyor of the plurality of conveyors and to cut off the power transmission and that is capable of transmitting a power from the driving source to the plurality of conveyors;
a processor configured to subject the processing object to predetermined processing; and
a moving mechanism configured to move, upon cut-off of the power transmission by the clutch, the at least one conveyor along a second direction different from the first direction so that the at least one conveyor is located in the processor.

7. A conveyance method, comprising:
supplying a power from a driving source to a plurality of conveyors via a transmission mechanism, to thereby cause the plurality of conveyors to convey a processing object along a first direction;
using a clutch provided to the transmission mechanism to cut off power transmission from the driving source to at least one conveyor of the plurality of conveyors; and
moving the at least one conveyor, to which the power transmission is cut off, along a second direction different from the first direction.

8. A processing method, comprising:
supplying a power from a driving source to a plurality of conveyors via a transmission mechanism, to thereby cause the plurality of conveyors to convey a processing object along a first direction;
using a clutch provided to the transmission mechanism to cut off power transmission from the driving source to at least one conveyor of the plurality of conveyors;
moving the at least one conveyor, to which the power transmission is cut off, along a second direction different from the first direction; and
subjecting the processing object carried by the at least one conveyor moved, to predetermined processing.
